(19) United States
(12) Patent Application Publication
(10) Pub. No.: US 2026/0005984 A1
(43) Pub. Date: Jan. 1, 2026

(54) Configuring Multiple Layer 1 Crossbar Chips

(71) Applicant: Arista Networks, Inc., Santa Clara, CA (US)

(72) Inventors: Nelson Enrique PEREZ, Burlingame, CA (US); Paul Martin FALLON, Mountain View, CA (US); Deepak SEBASTIAN, San Francisco, CA (US); Zeyad TAMIMI, Vancouver (CA); Yiming PAN, San Jose, CA (US); Ian David DUNKERLEY, Sydney (AU)

(21) Appl. No.: 18/758,004

(22) Filed: Jun. 28, 2024

(51) Int. Cl. H04L 49/101; H04L 49/253

(52) U.S. Cl. CPC H04L 49/101; H04L 49/254

(57) ABSTRACT

Electrical paths between ports (interfaces) of a network device are provided using an arrangement of interconnected Layer 1 (L1) crossbar switches in the network device. The network device includes internal data tables, e.g., a reachability table and a plurality of Layer 1 forwarding tables. These data tables are generated from a description of the crossbar chips in the network device. Heuristics are used to define one or more paths through the crossbar switches to connect between user-specified ports on the network device. The heuristics can select paths between ports based on criteria such a lowest latency, path stability (i.e., minimizing disruption to existing paths), and the like. The heuristic can be driven by a user who specifies via a CLI one or more crossbar switches on the path between the specified ports.

### BACKGROUND

A crossbar is a device that can dynamically connect any of its input serializer/de-serializer circuits (SerDes) to one or more of its output SerDes. Within a particular network device, this functionality can be used to forward traffic from one port to one or more ports on the system. A network device can be configured with multiple crossbars (i.e. arranged in a CLOS configuration) to achieve interconnectivity across several or all ports on the system.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 represents a network device configured in accordance with the present disclosure.

FIG. 2 is a high level representation of a crossbar network in accordance with the present disclosure.

FIGS. 3 and 4 represent examples of a crossbar network.

FIG. 5 represents infrastructure in a network device for routing paths in accordance with the present disclosure.

FIG. 6 is an illustrative crossbar network for explanation purposes.

FIG. 7 represents a reachability table in accordance with some embodiments.

FIGS. 8A-8D represent Layer 1 forwarding tables in accordance with some embodiments.

FIG. 9 is a flow of operations for routing paths in accordance with the present disclosure.

### DETAILED DESCRIPTION

The present disclosure is directed to routing paths (e.g., electrical paths) between ports (interfaces) of a network device using an arrangement of interconnected Layer 1 (L1) crossbar (crosspoint) switches in the network device. Using several crossbar switch chips rather than a single, larger, crossbar chip to interconnect ports on the network device offers the possibility of optimizing for lower latency between local connections; i.e., connections between two physically nearby ports on the network device.

The present disclosure includes internal data tables, such as a reachability table and Layer 1 (L1) forwarding tables. These data tables are generated from a description of the switching hardware, including crossbar chips, in the network device. This hardware description includes a model of the crossbar chips and their respective serializer/de-serializer circuits (SerDes). In some embodiments, the hardware description can include (1) external physical connections between a chip and its surrounding chips or electrical components and (2) internal connections and capabilities as documented by the chip vendor.

The reachability table is a table of the interfaces of the network device. Each interface is associated with a set of interfaces that represents possible connections via the network of crossbar switches.

The L1 forwarding tables are a collection of data tables that encode direct and indirect reachability information for a given domain. A domain is a logical subset of SerDes on a given crossbar switch, such that any input SerDes in the subset can map to any output SerDes in the subset. The L1 forwarding tables can be queried using a given domain as a desired destination. The L1 forwarding tables will provide a SerDes that can be used as the point of traversal to reach the given domain.

The present disclosure further includes a route analyzer that autonomously (absent user intervention) generates the reachability table and L1 forwarding tables from an L1 topology model that is provided to the route analyzer. The topology model describes the physical hardware (crossbar switches) in the network device. The topology model includes chip information for each crossbar switch, such as number of SerDes, attributes of the SerDes, and the like. The model also includes connectivity information between the crossbar switches and other devices if necessary.

The present disclosure further includes the use of heuristics that use information contained in the reachability table and L1 forwarding tables to define one or more paths through the crossbar switches to connect between ports of the network device. In some embodiments, the heuristic can be driven by a port configuration file that specifies port-to-port connections. The heuristics can select paths between ports based on criteria such a lowest latency, path stability (i.e., minimizing disruption to existing paths), hardware data of the crossbar switch chips, and the like. In other embodiments, the heuristic can receive input from a user who specifies via a CLI one or more waypoints (e.g., crossbar switches) on the path between two ports. Other than the user specifying the ports and optional waypoints, the heuristic operates absent user intervention to select a path between ports.

The output of the heuristic is a data object (e.g., a data file, data structure in memory, etc.) that is used by the network device to program the crossbar switches with the desired paths.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

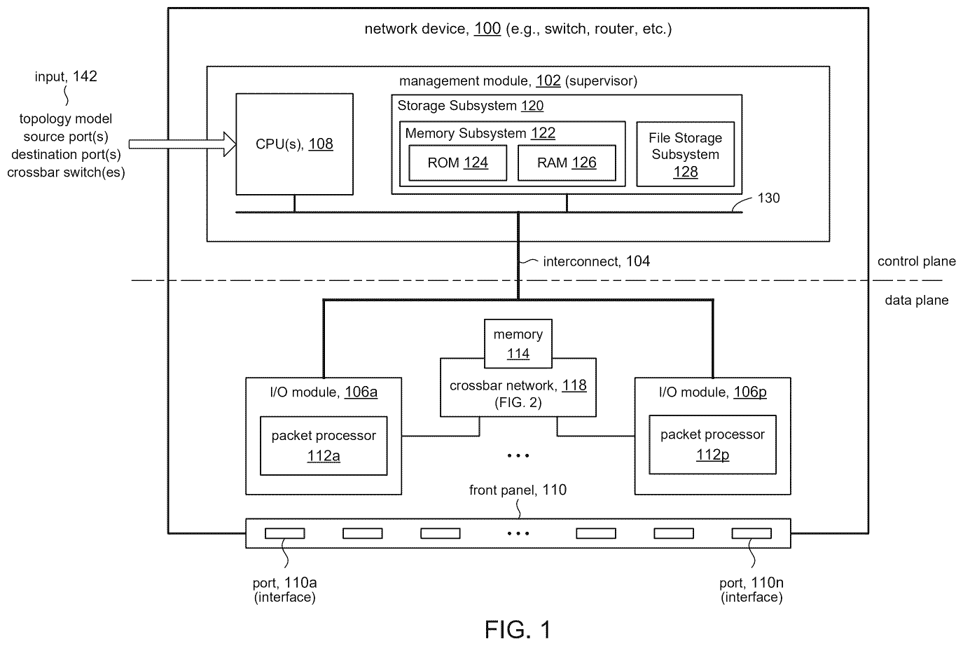

FIG. 1 is a schematic representation of a network device 100 (e.g., a router, switch, firewall, and the like) that can be adapted in accordance with the present disclosure. In some embodiments, for example, network device 100 can include one or more management modules 102, one or more I/O modules (switches, switch chips) 106a-106p, and a front panel 110 of I/O ports (physical interfaces, I/Fs) 110a-110n. Management module 102 can constitute the control plane of network device 100 (also referred to as the control layer or simply the central processing unit, CPU), and can include CPU(s) 108 for managing and controlling operation of network device 100 in accordance with the present disclosure. CPU(s) 108 can be a general-purpose processor, such as an Intel®/AMD® x86, ARM® microprocessor and the like, that operates under the control of software stored in a memory device/chips such as read-only memory (ROM) 124 or random-access memory (RAM) 126. The control plane provides services that include traffic management functions such as routing, security, load balancing, analysis, and the like.

CPU(s) 108 can communicate with storage subsystem 120 via bus subsystem 130. Other subsystems, such as a network interface subsystem (not shown in FIG. 1), may be on bus subsystem 130. Storage subsystem 120 can include memory subsystem 122 and file/disk storage subsystem 128. Memory subsystem 122 and file/disk storage subsystem 128 represent examples of non-transitory computer-readable storage devices that can store program code and/or data, which when executed by CPU(s) 108, can cause CPU(s) 108 to perform operations in accordance with embodiments of the present disclosure.

Memory subsystem 122 can include a number of memories such as main RAM 126 (e.g., static RAM, dynamic RAM, etc.) for storage of instructions and data during program execution, and ROM (read-only memory) 124 on which fixed instructions and data can be stored. File storage subsystem 128 can provide persistent (i.e., non-volatile) storage for program and data files, and can include storage technologies such as solid-state drive and/or other types of storage media known in the art.

CPU(s) 108 can run a network operating system stored in storage subsystem 120. A network operating system is a specialized operating system for network device 100. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 130 can provide a mechanism for the various components and subsystems of management module 102 to communicate with each other as intended. Although bus subsystem 130 is shown schematically as a single bus, alternative embodiments of the bus subsystem can utilize multiple buses.

The one or more I/O modules 106a-106p can be collectively referred to as the data plane of network device 100 (also referred to as the data layer, forwarding plane, etc.). Interconnect 104 represents interconnections between modules in the control plane and modules in the data plane. Interconnect 104 can be any suitable bus architecture such as Peripheral Component Interconnect Express (PCIe), System Management Bus (SMBus), Inter-Integrated Circuit (I2C), etc.

I/O modules 106a-106p can include respective packet processing hardware comprising packet processors 112a-112p (collectively 112) to provide packet processing and forwarding capability. Each I/O module 106a-106p can be further configured to communicate over one or more ports 110a-110n on the front panel 110 to receive and forward network traffic. Packet processors 112 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 112 can include forwarding lookup hardware such as, for example, but not limited to content addressable memory such as ternary CAMs (TCAMs) and auxiliary memory such as static RAM (SRAM).

Memory hardware 114 can include buffers used for queueing packets. I/O modules 106a-106p can access memory hardware 114 and ports 110a-110n via a crossbar network 118 configured in accordance with the present disclosure. It is noted that in other embodiments, the memory hardware 114 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

Input 142 can be provided to the network device 100 to configure the crossbar network 118 in accordance with the present disclosure. In various embodiments, input 142 can include a topology model of the crossbar network, one or more source ports and corresponding destination ports, one or more crossbar switch identifiers, and so on. Input 142 can come from a user (e.g., at runtime), a configuration file, or can be programmed in the network device (e.g., the topology can be programmed in a memory of the network device). These aspects of the present disclosure are discussed below.

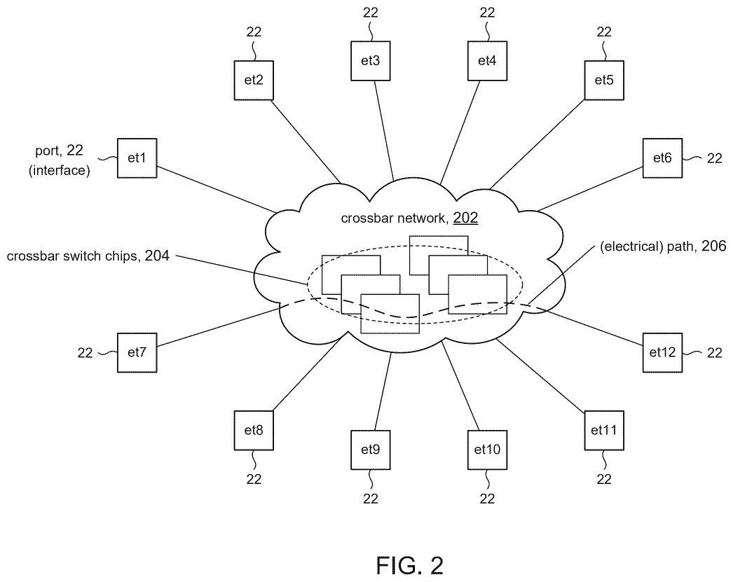

Referring to FIG. 2, shows a generalized representation of a crossbar network in accordance with the present disclosure. Crossbar network 202 comprises a network of interconnected crossbar switch chips 204. Ports (interfaces) 22 of a network device (e.g., network device 100) connect to the crossbar switch chips 204. Although the figures illustrate external ports, in the context of the present disclosure, it will be understood that “port” can refer to any interface on the network device, including interfaces that are external to the device and interfaces that are internal to the device. A port can be an external connector (e.g., RJ45 connector, pluggable optical module connector, etc.) on the front panel of the network device or a pin on an internal hardware resource.

In accordance with the present disclosure, the crossbar switch chips 204 can generally be programmed to provide a path between any two ports 22. FIG. 2, for example, shows an electrical path 206 between ports et7 and et12 that the crossbar switch chips 204 can be programmed to create.

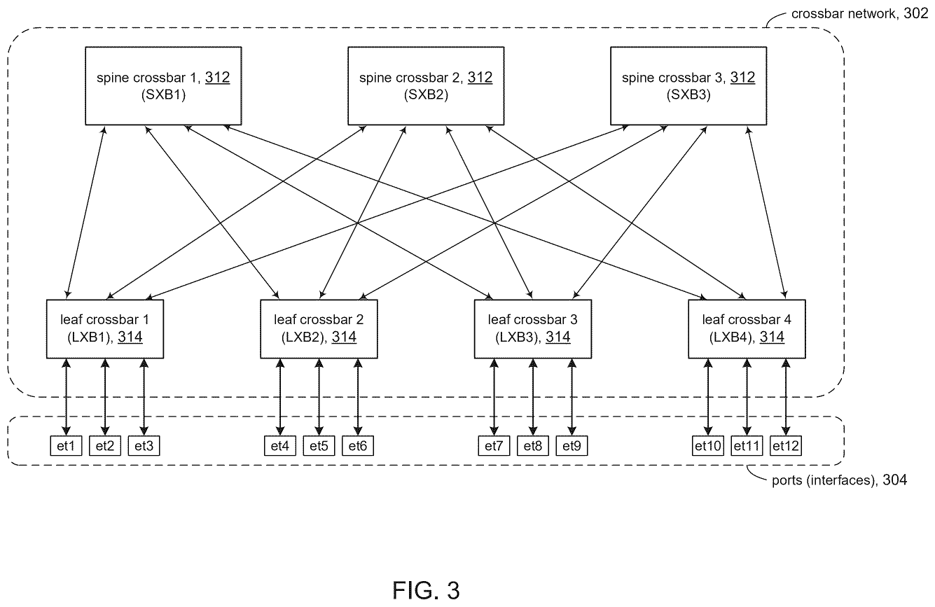

FIG. 3 shows a more concrete example of a crossbar network in a network device in accordance with some embodiments of the present disclosure. The figure illustrates a crossbar network 302 providing inter-connectivity for ports 304 of a network device (not shown) in accordance with some embodiments. It will be appreciated that the crossbar network 302 can be configured according to any suitable topology.

As an example, crossbar network 302 comprises crossbar switch chips 312 and 314. The crossbar switch chips 312, 314 are configured as a Clos network. Crossbar switch chips 312 serve as spine nodes and crossbar switch chips 314 serve as leaf nodes. In the example shown, the crossbar switch chips 312, 314 are configured as a fully unconstrained multipath network. In other words, the crossbar switch chips 312, 314 can be programmed to connect any port 304 to any other port. For example, a path between port et7 and port et12 can be created by programming connections between leaf crossbar 3 (LXB3), spine crossbar 3 (SXB3), and LXB4. It will be noted that, in principle, a different path between port et7 and port et12 can be created on different crossbar switch chips; e.g., LXB3-SXB1-LXB4, and so on.

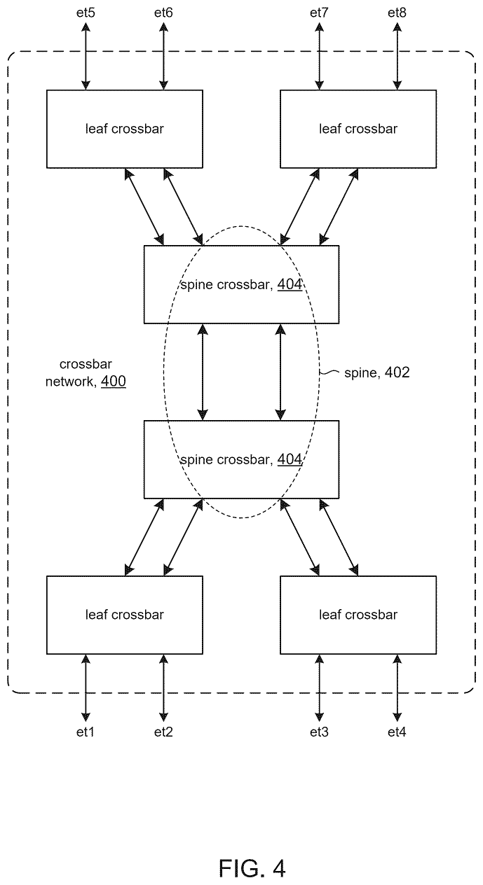

In some embodiments, the crossbar network can be configured in a resource constrained configuration wherein routing a path between one pair of ports precludes routing a path between another pair of ports. Referring for a moment to another example of a crossbar network shown in FIG. 4. The crossbar network 400 represents an example of a resource constrained configuration. There are four ports on either side of the spine 402, namely ports et1 to et4 on one side of the spine and ports et5 to et8 on the other side of the spine. However, only two paths can cross the spine 402 at a time because there are only two links between the spine crossbars 404.

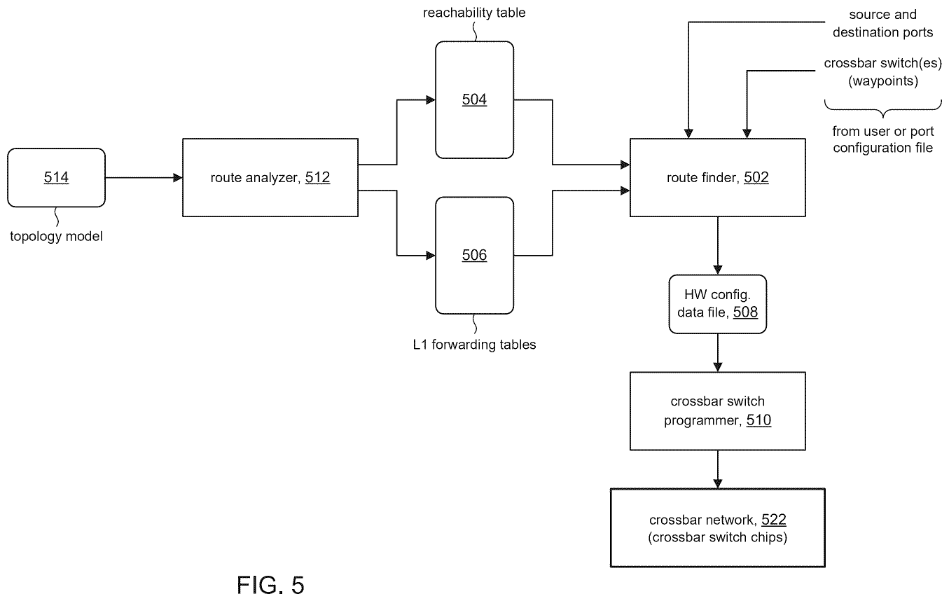

FIG. 5 represents an example of the infrastructure (processes and data tables) in a network device for routing paths through a crossbar network in accordance with the present disclosure. Route finder 502 can be a process, subroutine, process thread, etc. that runs on the network device (e.g., in the control plane). The route finder 502 can take as input a source port on the network device and a destination port on the network device and compute a path through one or more crossbar switch chips in the crossbar network 522 that leads from the source port to the destination port. In some embodiments, the route finder 502 can take as input one or more crossbar switch identifiers to constrain the path to include the identified crossbar switches. These inputs can come from a user, e.g., via a suitable interface such as a command line interface (CLI). For example, a user via the CLI can specify the source and destination ports. The user can also constrain the path to include one or more crossbar switches (waypoints). The inputs can come from a data file that includes port configurations for the network device. The port configuration can comprise a list of source/destination pairs to configure the ports on the network device.

In some embodiments, the route finder 502 uses a reachability table 504 which comprises reachability information between the ports on the network device. This aspect of the present disclosure is described in more detail below. Briefly, however, the reachability information for a given port includes the set of ports that can be reached by the given port.

In some embodiments, the route finder 502 uses L1 forwarding tables 506 comprising a collection of data tables that encode indirect and direct reachability information for a given domain. A domain is a logical subset of SerDes on a given crossbar switch, such that any input SerDes in the subset can map to any output SerDes in the subset. The L1 forwarding tables can be queried using a given domain as a desired destination. The L1 forwarding tables will provide a SerDes that can be used as the point of traversal to reach the given domain.

The route finder 502 can generate a hardware configuration data file 508 that represents the connections between the crossbar switches in the crossbar network to create the paths between the specified source and destination ports. The hardware configuration data file 508 comprises instructions for programming the crossbar switch chips in the crossbar network 522. In some embodiments, the hardware configuration can be a data object in memory.

Crossbar switch programmer 510 can be a process that runs on the network device. The crossbar switch programmer 510 can read the instructions in hardware configuration data file 508 to program the crossbar switch chips in the crossbar network 522.

Route analyzer 512 can be a software module or subroutine that runs on the network device. The route analyzer 512 can accept a topology model 514 of the crossbar network 522 to generate the reachability table 504 and the L1 forwarding tables 506. The topology model 514 represents the interconnections between the crossbar switch chips in the crossbar network and hardware constraints of the crossbar switch chips.

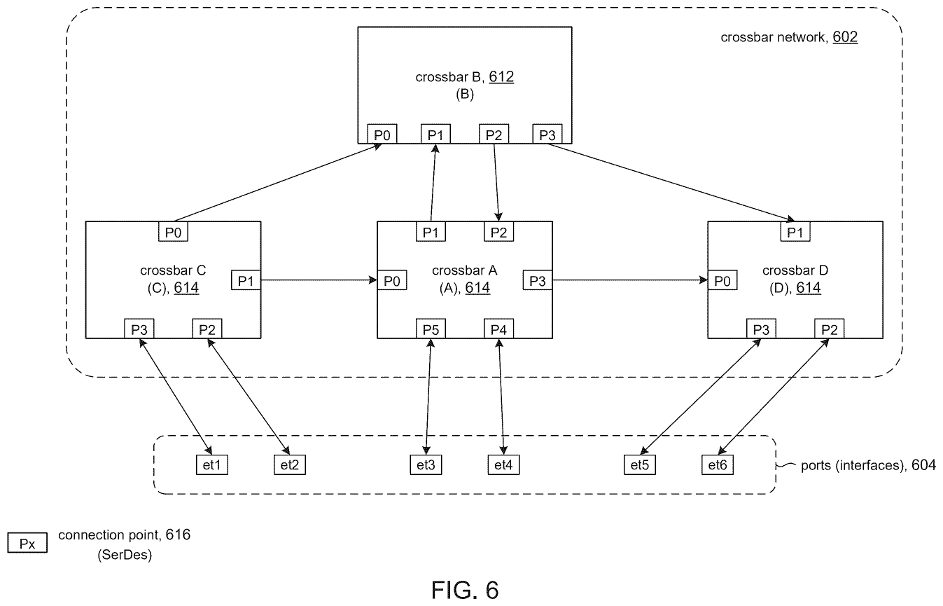

FIG. 6 shows a simplified illustrative configuration of a crossbar network in a network device (e.g., 100) to serve as an example to describe processing in accordance with the present disclosure. Crossbar network 602 comprises crossbar switch chips 612 (spine), 614 (leaf). It will be appreciated that the crossbar network can be other than a spine-leaf network.

Each crossbar switch chip 612, 614 includes circuitry (e.g., serializer/deserializer, SerDes), also referred to as connection points 616 for connecting to other crossbar switch chips and/or to ports 604 of the network device. For example, each connection point 616 on a crossbar switch chip 612 connects to a leaf crossbar switch chip 614. On the other hand, connection points 616 on the leaf crossbar switch chips 614 connect either to spine crossbar switch chip 612 or to a port 604. The connections can be unidirectional (e.g., from connection point P3 on crossbar A to connection point P0 on crossbar D) or bidirectional (e.g., between connection point P3 on leaf crossbar C and port et1).

Crossbar switch chip 612 operates to connect one of its connection points 616 to another of its connection points, forming what can be viewed as a wire connection between the two connection points. This allows the crossbar switch chips to establish a path between two ports 604. Consider ports et2 (connected to connection point P2 on crossbar C) and et5 (connected to P3 on crossbar D), for example. A path can be established between port et2 and port et5 as follows:
On crossbar C, connect P2 (which is bi-directionally connected to port et2) to P1. Note there is a unidirectional connection from P1 on crossbar C to P0 on crossbar A.
On crossbar A, connect P0 to P3. Note there is a unidirectional connection from P3 on crossbar A to P0 on crossbar D.
On crossbar D, connect P0 to P3 (which is bi-directionally connected to port et5). This completes a path for communication from port et2 to port et5.
It can be seen that other paths between ports et2 and et5 exist; e.g.:

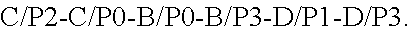

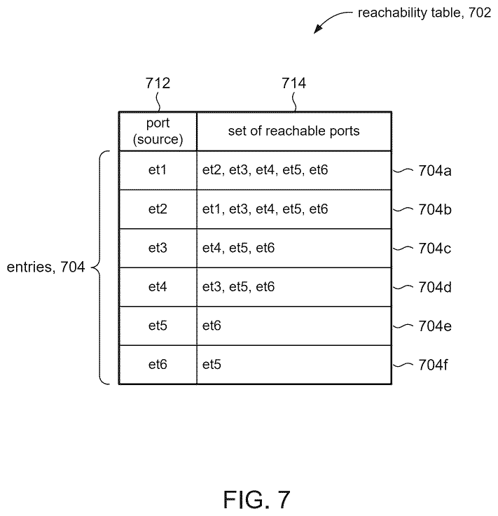

FIG. 7 is a generalized representation of a reachability table (e.g., 504) in accordance with some embodiments. Reachability refers to which ports of the network device can reach which of the other ports of the network device, and is generally based on the connectivity capabilities of the hardware. A port can be reachable through any number of hops and any number of crossbars or other electrical components. Reachability table 702 includes entries 704 for respective ports of the network device. Each entry 704 indicates one or more ports that a given port can reach. Each entry 704 comprises a port data field 712 and a set of reachable-ports data field 714.

The example shown in FIG. 7 is based on the example crossbar network 602 of FIG. 6. In some embodiments, reachability entries 704 indicate reachability in one direction. As such, port data field 712 represents a source port and port data field 714 represents the destination ports that the source port can reach. For example, the reachability configuration represented by reachability table 702 specifies that port et1 can reach ports et2, et3, et4, et5, et6 (entry 704a). Likewise, port et2 can reach ports et1, et3, et4, et5, et6 (entry 704b), and so on. In order to to configure bi-directional communication between two ports (e.g., et5, et6), the reachability table includes an entry 704e that indicates port et5 (as source) can reach port et6 (as destination) and another entry 704f that indicates port et6 (as source) can reach port et5 (as destination).

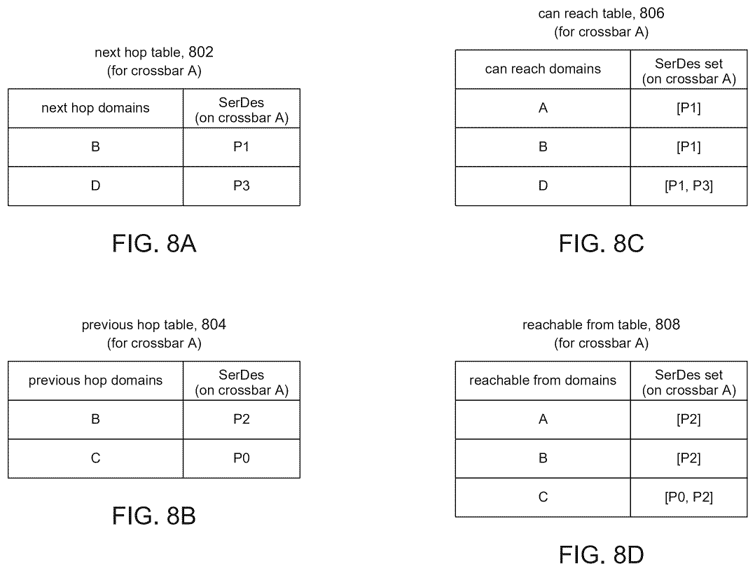

FIGS. 8A-8D are generalized representations of data tables that constitute L1 forwarding tables (e.g., 506) in accordance with some embodiments. In some embodiments, each crossbar can be associated with L1 forwarding tables that describe SerDes-based reachability between crossbar switch chips. The data tables express reachability in terms of sets of SerDes called domains. Each crossbar switch chip is associated with a corresponding set of L1 forwarding tables. The data tables shown in FIGS. 8A-8D constitute the L1 forwarding tables for crossbar A as shown in FIG. 6, with the understanding that corresponding L1 forwarding tables exist for crossbar B, crossbar C, and crossbar D.

FIG. 8A represents a data table 802 (next hop table) for crossbar A. The next hop table 802 identifies domains that crossbar A can reach in one hop. With respect to the example shown in FIG. 6, for instance, crossbar A can reach crossbar B in one hop via SerDes P1 on crossbar A. Likewise, crossbar A can reach crossbar D in one hop via SerDes P3 on crossbar A.

FIG. 8B represents a data table 804 (previous hop table) for crossbar A. The previous hop table 804 identifies domains that can reach crossbar A in one hop. With respect to the example shown in FIG. 6, for instance, crossbar B can reach crossbar A (on SerDes P2 of A) in one hop. Likewise, crossbar C can reach crossbar A (on SerDes P0 of A) in one hop.

FIG. 8C represents a data table 806 (can-reach table) for crossbar A. The can-reach table 806 identifies domains that crossbar A can reach, irrespective of how many hops are needed to reach those domains. The SerDes set in the can-reach table 806 associated with a given domain is the collection of SerDes in crossbar A that will lead to that domain. With respect to the example shown in FIG. 6, for instance, crossbar A can “reach” itself on SerDes P1 (via crossbar B), and so the set of SerDes on crossbar A that can reach crossbar A is [P1]. Likewise, crossbar A can directly reach crossbar B on SerDes P1, and so the set of SerDes on crossbar A that can reach crossbar B is [P1]. Finally, crossbar A can reach crossbar D on SerDes P1 (via crossbar B). Crossbar A can directly reach crossbar D on SerDes P3, and so the set of SerDes on crossbar A that can reach crossbar D is [P1, P3]. Note, in the example in FIG. 6, crossbar C is not reachable from crossbar A because of the configuration of unidirectional SerDes.

FIG. 8D represents a data table 808 (reachable-from table) for crossbar A. The reachable-from table 808 identifies domains that can reach crossbar A (irrespective of how many hops are needed), and on which SerDes on crossbar A they will come in on. With respect to the example shown in FIG. 6, for instance, crossbar A can be “reached” from itself on SerDes P2 (via crossbar B), and so crossbar A is reachable from crossbar A on the following set of SerDes [P2]. Likewise, crossbar A can be directly reached from crossbar B on SerDes P2, and so crossbar A is reachable from crossbar B on the following set of SerDes [P2]. Completing the description of the reachable-from table 808 for crossbar A, crossbar A can be reached from crossbar C on SerDes P0 and SerDes P2 (via crossbar B), and so crossbar A is reachable from crossbar C on the following set of SerDes [P0, P2].

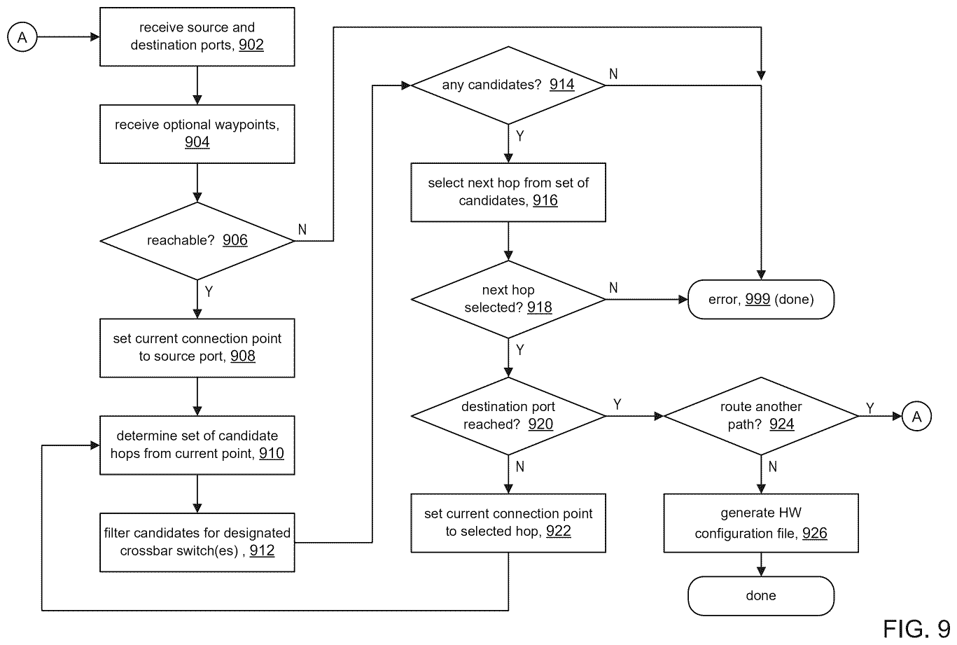

Referring to FIG. 9, the discussion will now turn to a high-level description of processing in a network device (e.g., 100, FIG. 1) for routing paths through a crossbar network in accordance with the present disclosure. Depending on a given implementation, the processing may be performed entirely in the control plane or entirely in the data plane, or the processing may be divided between the control plane and the data plane. In some embodiments, the network device can include one or more processing units (circuits), which when operated, can cause the network device to perform processing in accordance with FIG. 9. Processing units (circuits) in the control plane, for example, can include general CPUs that operate by way of executing computer program code stored on a non-volatile computer readable storage medium (e.g., read-only memory); e.g., CPU 108 in the control plane (FIG. 1) can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, each of the packet processors 112a-112p in the data plane (FIG. 1) can be a specialized processor. The operation and processing blocks described below are not necessarily executed in the order shown. Operations can be combined or broken out into smaller operations in various embodiments. Operations can be allocated for execution among one or more concurrently executing processes and/or threads.

At operation 902, the network device can receive source and destination ports to be routed. In some embodiments, the source and destination ports can be input via a CLI by a user. Because the reachability from one port to another is unidirectional, one port is designated the “source” and the other port is designated the “destination.”

At operation 904, the network device can receive one or more optional waypoints on the routed path. The path can be routed based only on the source port and the destination port. In some embodiments, however, the user may want to specify that the path between the source and destination ports be routed through one or more crossbar switch chips as waypoints between the source port and the destination port. Referring to FIG. 6, for example, suppose the source port is et4 and the destination port is et5. There are two paths: crossbar A to crossbar B to crossbar D, or crossbar A to crossbar D. However, the user may want the routed path to include crossbar B as a waypoint and thus can specify crossbar B as a waypoint. In some embodiments, the waypoint can be a specific connection point (SerDes) on a specific crossbar switch chip.

At this point, the source and destination ports and one or more optional waypoints have been specified by a user. Processing from this point forward can proceed autonomously, absent user intervention.

At decision point 906, a determination is made whether the source port can reach the destination port. Stated differently a determination is made whether the destination is port reachable from the source port. The determination can be made using a reachability table. Referring to FIGS. 6 and 7 for example, suppose the source port is et4 and the destination port is et5. Entry 704d (source port et4) in reachability table 702 would be accessed and indicate that destination et5 is reachable from et4. On the other hand, if the source is et4 and the destination is et1, entry 704d (source port et4) would be accessed and indicate that destination port et1 is not reachable from et4. If the destination port is reachable from the source port, the network device can continue processing at operation 908. If the source port cannot reach the destination port, the network device can continue processing at operation 999 to throw a suitable error message, and processing in accordance with FIG. 9 can be deemed concluded.

At operation 908, the network device can initialize a “current” connection point as a starting point for the routing heuristic. The current connection point can be the SerDes to which the source port is connected. As can be seen in FIG. 6, ports 604 are connected to respective connection points 616 on respective crossbar switch chips 614. Using the example where the source and destination ports are et4 and et6, respectively, FIG. 6 shows that port et4 is connected to connection point P4 on crossbar A and port et6 is connected to P4 on crossbar A. The current connection point is set (initialized) to the connection point (SerDes) to which the source port is connected. Using the example that source port is et4, the current connection point can be initially set to P4 on crossbar A.

At operation 910, the network device can determine a set of candidate hops from the current connection point (P4 on crossbar A) that can reach P2 on crossbar D, the connection point to which the destination port is connected. Using the L1 forwarding tables for crossbar A shown in FIGS. 8A-8D, for example, the set of candidate hops can be determined as follows:
1. Using the can-reach table 806, we see that crossbar A can reach crossbar B via P1 on crossbar A and that crossbar A can reach crossbar D via P1 and P3 on crossbar A.
2. Using the next hop table 802, we see that the next hop from crossbar A to crossbar B is P1 on crossbar A. Likewise, we see that the next hop from crossbar A to reach crossbar D is P3 on crossbar A.
3. The set of candidate hops from step 2 would be [P1, P3].

At operation 912, the network device can filter the set of candidate next hops for any waypoints (crossbar switch chips) that may have been received at operation 904. As noted above in operation 904, the user can specify waypoints (crossbar switches, and optionally connection points) on the routed path. If such waypoints are designated, then the set of candidate next hops can be filtered to remove all but the next hops that pass through the designated waypoint(s).

At decision point 914, a determination can be made whether there are any candidate next hops. For example, no candidates may result from operation 910. Or, if operation 910 produced candidate next hops, those candidates may get removed if waypoints were received at operation 904. If there are candidate next hops, the network device can continue processing at operation 916. If there are no candidate next hops, the network device can continue processing at operation 999 to throw a suitable error message, and processing in accordance with FIG. 9 can be deemed concluded.

At operation 916, the network device can select a next hop from among the candidate next hops in accordance with any suitable selection heuristic. In some embodiments, for example, the next hop can be selected based on minimizing path latency. In other embodiments, the next hop can be selected based on having the least likelihood of having to re-route other paths.

At decision point 918, a determination can be made whether or not a next hop was selected from among the candidate next hops. For example, it may happen that none of the candidate next hops could not satisfy the criteria of the selection heuristic. If a next hop was selected, the network device can continue processing at decision point 920. If a next hop was not able to be selected from among the candidate next hops, the network device can continue processing at operation 999 to throw a suitable error message, and processing in accordance with FIG. 9 can be deemed concluded.

At decision point 920, if the selected next hop is connected to the destination port, then a path from the source port to the destination port has been routed, and processing can proceed to decision point 924. If the selected next hop is not connected to the destination port, then the process of routing a path from the source port to the destination port continues, and processing can proceed to operation 922.

At operation 922, the network device can advance the current location on the path to the next point by setting the current connection point to the selected next hop. Processing can return to operation 910.

At decision point 924, if multiple pairs of source and destination ports are to be routed, processing can return to operation 902 to route the next pair of source and destination ports. Otherwise, the process of routing a path from the source port to the destination port can be deemed completed, and processing can proceed to operation 926.

At operation 926, the network device can generate a hardware (HW) configuration file. The HW configuration file can contain instructions for programming the crossbar switch chips in the crossbar network. Processing in accordance with FIG. 9 can be deemed concluded.

1. A method in a network device for configuring a path between a source port on the network device and a destination port on the network device using a plurality of crossbar switch chips, the method comprising the network device:
using a reachability table to confirm that the destination port is reachable from the source port;
using a heuristic to identify a plurality of selected hops from a plurality of Layer 1 forwarding tables, wherein each selected hop represents a connection point on one of the crossbar switch chips, wherein the plurality of selected hops represents a first connection point on a first crossbar switch chip to which the source port is connected, a second connection point on a second crossbar switch chip to which the destination port is connected, and one or more intermediate connection points on respective intermediate crossbar switch chips between the first and second crossbar switch chips; and
programming the first, second, and intermediate crossbar switch chips to create a path between the source and destination ports.

2. The method of claim 1, wherein using a heuristic to identify the plurality of selected hops comprises:
[a] identifying a set of one or more candidate hops that are connected to a current hop using the Layer 1 forwarding tables;
[b] using the heuristic to select a hop from the set of candidate hops as the next current hop; and
repeating [a] and [b] until the current hop reaches the second connection point.

3. The method of claim 1, wherein using a heuristic to identify the plurality of selected hops comprises:
[a] using the heuristic to identify a next crossbar switch chip; and
[b] identifying a hop that is connected to the next crossbar switch chip using the Layer 1 forwarding tables;
repeating [a] and [b] until the current hop reaches the second connection point.

4. The method of claim 1, wherein the heuristic to identify the plurality of selected hops is based on minimizing latency between hops.

5. The method of claim 1, wherein the heuristic to identify the plurality of selected hops is based on minimizing rerouting of previously programmed paths between pairs of ports on the network device.

6. The method of claim 1, further comprising receiving input from a user that specifies the source and destination ports and at least one crossbar switch chip as a waypoint on the path, wherein the heuristic to identify the plurality of selected hops selects a connection point on the user-specified crossbar switch chip.

7. The method of claim 1, further comprising:
receiving a topology description that describes the plurality of crossbar switches and connectivity between connection points on the plurality of crossbar switch chips;
generating the reachability table from the topology description; and
generating the Layer 1 forwarding tables from the topology description.

8. The method of claim 7, further comprising performing generating the reachability and Layer 1 forwarding tables autonomously absent user intervention.

9. A network device comprising:
a plurality of ports;
a plurality of crossbar switch chips connected in a crossbar network;
one or more computer processors; and
a computer-readable storage device comprising instructions for controlling the one or more computer processors to:
receive a source port and a destination port among the plurality of ports;
verify that the source port can reach the destination port;
identify a plurality of selected hops between the source port and the destination port, wherein each selected hop represents a connection point on one of the crossbar switch chips, wherein the plurality of selected hops represents at least a first connection point on a first crossbar switch chip to which the source port is connected and a second connection point on a second crossbar switch chip to which the destination port is connected; and
program the at least first and second crossbar switch chips to create a path between the source and destination ports.

10. The network device of claim 9, wherein the plurality of selected hops is autonomously identified absent user intervention.

11. The network device of claim 9, wherein the computer-readable storage device further comprises instructions for controlling the one or more computer processors to verify that the source port can reach the destination port using a reachability table; and identify a plurality of selected hops between the source port and the destination port using a plurality of Layer 1 forwarding tables.

12. The network device of claim 9, wherein the computer-readable storage device further comprises instructions for controlling the one or more computer processors to identify a plurality of selected hops between the source port and the destination port using a heuristic that:
[a] identifies a set of one or more candidate hops that are connected to a current hop using the Layer 1 forwarding tables;
[b] uses the heuristic to select a hop from the set of candidate hops as the next current hop; and
repeats [a] and [b] until the current hop reaches the second connection point.

13. The network device of claim 12, wherein the heuristic identifies the plurality of selected hops based on minimizing latency between hops.

14. The network device of claim 12, wherein the heuristic identifies the plurality of selected hops is based on minimizing rerouting of previously programmed paths between pairs of ports on the network device.

15. The network device of claim 9, wherein the computer-readable storage device further comprises instructions for controlling the one or more computer processors to receive input from a user that specifies the source and destination ports and at least one crossbar switch chip as a waypoint on the path, wherein the plurality of selected hops includes a connection point on the user-specified crossbar switch chip.

16. A non-transitory computer-readable storage device in a network device, the non-transitory computer-readable storage device having stored thereon computer executable instructions, which when executed, cause the network device to:
receive a source port and a destination port from among a plurality of ports on the network device;
verify that the source port can reach the destination port;
autonomously, absent user intervention, identify a plurality of selected hops between the source port and the destination port according to a heuristic, wherein each selected hop represents a connection point on one of a plurality of crossbar switch chips in the network device, wherein the plurality of selected hops comprises at least a first connection point on a first crossbar switch chip to which the source port is connected and a second connection point on a second crossbar switch chip to which the destination port is connected; and
program the at least first and second crossbar switch chips to create a path between the source and destination ports.

17. The non-transitory computer-readable storage device of claim 16, wherein the computer executable instructions, which when executed, further cause the network device to autonomously identify a plurality of selected hops between the source port and the destination port using a heuristic that:
[a] identifies a set of one or more candidate hops that are connected to a current hop using the Layer 1 forwarding tables;
[b] uses the heuristic to select a hop from the set of candidate hops as the next current hop; and
repeats [a] and [b] until the current hop reaches the second connection point.

18. The non-transitory computer-readable storage device of claim 17, wherein the computer executable instructions, which when executed, further cause the network device to identify the plurality of selected hops based on minimizing latency between hops.

19. The non-transitory computer-readable storage device of claim 17, wherein the computer executable instructions, which when executed, further cause the network device to identify the plurality of selected hops is based on minimizing rerouting of previously programmed paths between pairs of ports on the network device.

20. The non-transitory computer-readable storage device of claim 16, wherein the computer executable instructions, which when executed, further cause the network device to receive input from a user that specifies the source and destination ports and at least one crossbar switch chip as a waypoint on the path, wherein the plurality of selected hops includes a connection point on the user-specified crossbar switch chip.
